(19) United States
(12) Patent Application Publication
(10) Pub. No.: US 2009/0078702 A1
(43) Pub. Date: Mar. 26, 2009

(54) TRACKABLE CART

(76) Inventors: Robert Lee Martin, JR., Kenosha, WI (US); Zachary Thomas Martin, Dallas, TX (US); Matthew Lester Dannenfeldt, Libertyville, IL (US); Jeremy Hector, Pleasant Prairie, WI (US)

Correspondence Address: CARLSON, GASKEY & OLDS, P.C., 400 WEST MAPLE ROAD, SUITE 350, BIRMINGHAM, MI, 48009, US

(21) Appl. No.: 12/236,785

(22) Filed: Sep. 24, 2008

Related U.S. Application Data
(60) Provisional application No. 60/974,688, filed on Sep. 24, 2007.

(51) Int. Cl. B65D 51/04; G08G 1/123; B23P 11/00

(52) U.S. Cl. 220/200; 340/988; 29/428

(57) ABSTRACT

An example trackable cart includes a body having an upper body portion defining an opening for loading and unloading items from the body and a lid for closing the opening of the body. The lid pivotably attaches to the body along a hinge axis. The trackable cart includes an identifier contained adjacent the hinge axis.

### CROSS-REFERENCE TO RELATED APPLICATIONS

This application claims priority to U.S. Provisional Application No. 60/974,688, which was filed 24 Sep. 2007 and is incorporated herein by reference.

### BACKGROUND

This invention generally relates to carts and, more particularly, to trackable carts.

Carts for moving recyclables, trash, and other items are well known. Some municipalities provide residents with carts, especially large, roll-out recyclable carts. The residents load the cart with recyclables and then roll filled carts to a collection location. A recyclable truck next maneuvers to a position adjacent the collection location. A lift arm extending from the recyclable truck lifts and rotates a filled cart to pour the recyclables into the recyclable truck. Moving recyclables to the truck in this manner is often referred to as “tipping” the cart. Once emptied, the lift arm returns the cart to the collection location.

Carts may include identifiers that facilitate associating the cart with a particular location. The identifiers assist during waste collection billing or when tracking recycling participation, such as billing the resident for emptying recyclables from their carts, for example. Adding identifiers to recyclable carts complicates the cart manufacturing process.

### SUMMARY

An example trackable cart includes a body having an upper body portion defining an opening for loading and unloading items from the body and a lid for closing the opening of the body. The lid pivotably attaches to the body along a hinge axis. The trackable cart includes an identifier contained adjacent the hinge axis.

Another example trackable cart includes a body having an upper body portion defining an opening for loading and unloading items from the body and a lid for closing the opening of the body. A hinge member pivotally connects the body to the lid. The trackable cart further includes a handle and an identifier. One of the hinge member and the handle contains the identifier.

An example method of assembling a trackable cart includes securing a non-optical identifier relative a cart, the cart having an associated optical identifier. The method further includes reading the non-optical identifier and associating the non-optical identifier with the optical identifier. In one example, the non-optical identifier is written with information about the optical identifier, which associates the non-optical identifier with the optical identifier.

These and other features of the example disclosure can be best understood from the following specification and drawings, the following of which is a brief description:

### BRIEF DESCRIPTION OF THE DRAWINGS

FIG. 1 is a perspective view of an example roll-out recyclable cart;

FIG. 2 is a perspective view of a recyclable truck tipping the FIG. 1 roll-out recyclable cart;

FIG. 3 is a front view of a portion of the lift arm extending from the FIG. 2 roll-out recyclable cart;

FIG. 4 schematically shows an example roll-out cart tracking system for tracking the FIG. 1 roll-out recyclable cart;

FIG. 5 is a perspective, partial exploded view of another example roll-out recyclable cart;

FIG. 6 is a perspective view of an example fixture assembly for associating a cart with a non-optical identifier;

FIG. 7 shows the FIG. 5 cart within the FIG. 6 fixture; and

FIG. 8 shows an example display from the FIG. 6 fixture.

### DETAILED DESCRIPTION OF THE PREFERRED EMBODIMENT

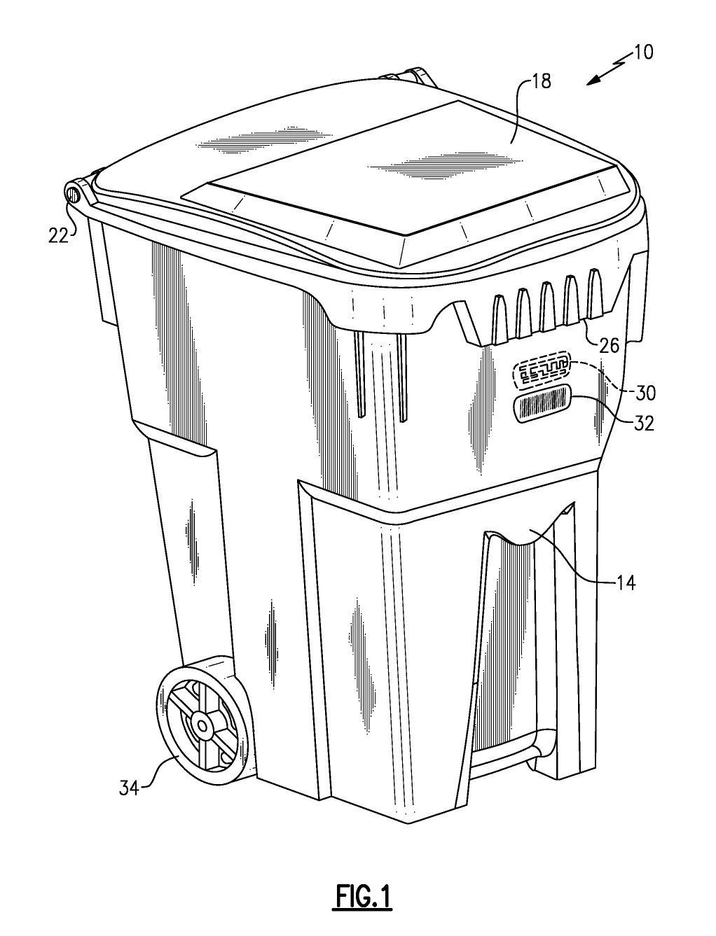

FIG. 1 illustrates an example roll-out recyclable cart 10 having a hollow body portion 14 coverable with a lid member 18. A hinge member 22 connects the lid member 18 to the hollow body portion 14. The roll-out recyclable cart 10 includes handle members 26 and wheels 34 for manipulating the position of the roll-out recyclable cart 10. Other examples include using the roll-out recyclable cart 10 for collecting other items, such as trash, non-recyclable items, or leaves.

The roll-out recyclable cart 10 includes a non-optical identifier 30 secured to an exterior surface of the roll-out recyclable cart 10. In this example, the non-optical identifier 30 is a radio frequency identification (RFID) tag. The roll-out recyclable cart 10 also includes an optical identifier 32, such as a barcode sticker, secured to an exterior surface of the roll-out recyclable cart 10. The lid member 18 and the hollow body portion 14 are typically injection molded from a polymer material such as High Density Polyethylene (HDPE). The non-optical identifier 30 is in-molded during the injection molding process to secure the non-optical identifier 30 to the roll-out recyclable cart 10, and the optical identifier 32 is secured to an outer surface of the hollow body portion 14 using adhesive, for example. In this example, the non-optical identifier 30 and the optical identifier 32 contain similar information about the roll-out recyclable cart 10.

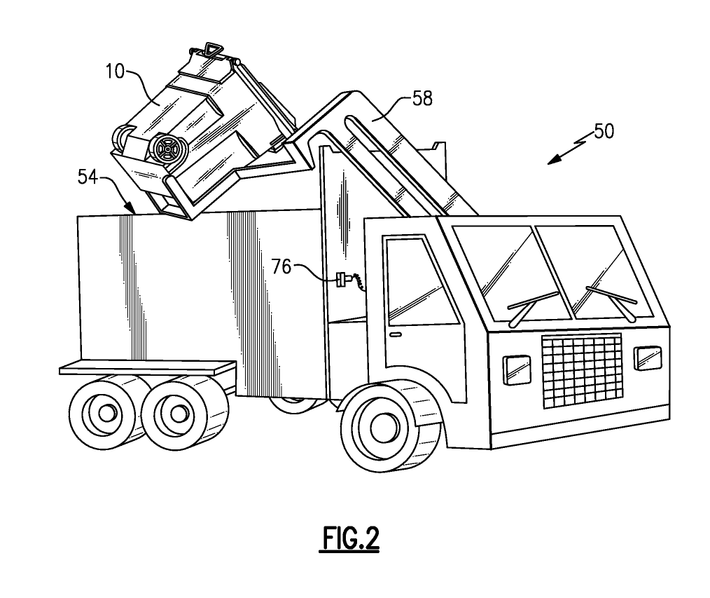

As shown in FIG. 2, a lift arm 58 extending from a recyclable truck 50 lifts and tips the roll-out recyclable cart 10 to empty recyclables from the roll-out recyclable cart into the recyclable bin 54. A pair of forks 62 extending from the lift arm 58 receive the roll-out recyclable cart 10 and maintain the position of the roll-out recyclable cart 10 relative to the lift arm 58 while lifting the roll-out recyclable cart 10 over the recyclable bin 54. After recyclables move from the roll-out recyclable cart 10 into the recyclable bin 54, the lift arm 58 returns the roll-out recyclable cart 10 to the collection location position adjacent the recyclable truck 50. As known, a recyclable truck operator manipulates the roll-out recyclable cart 10 between a received position within the forks 62 and the collection location.

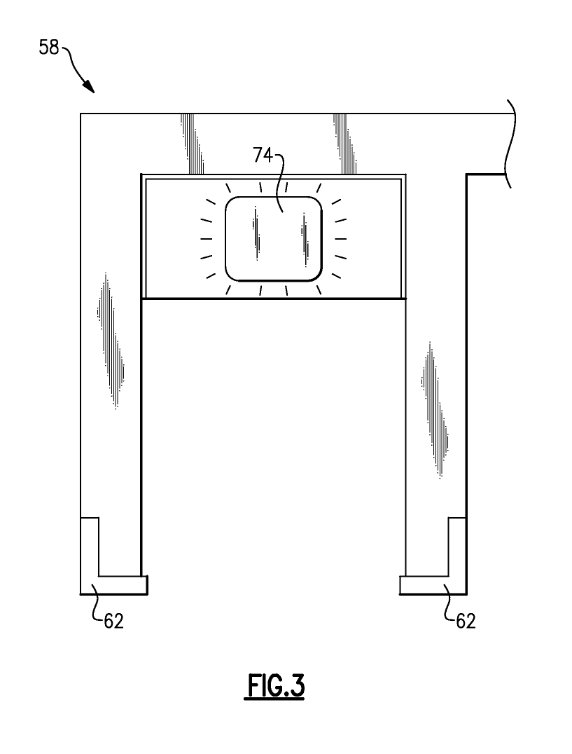

FIG. 3 illustrates a portion of the lift arm 58 having the forks 62 for receiving the roll-out recyclable cart 10. A reader 74 mounts to a portion of the lift arm 58. When the roll-out recyclable cart 10 of FIG. 2 is received within the forks 62 of the lift arm 58, the non-optical identifier 30 generally aligns with the reader 74. In such a position, the reader 74 communicates with the non-optical identifier 30 in a known manner. For example, the reader 74 may transmit a radio frequency signal to the non-optical identifier 30, which returns a signal to the reader 74 containing identification information. As discussed previously, the example non-optical identifier 30 in this example is a passive RFID tag, which relies on the radio frequency signal from the reader 74 to provide the necessary power to the non-optical identifier 30 for transmitting a response back to the reader 74. Other examples include mounting the reader 74 to the recyclable bin 54.

The non-optical identifier 30 contains identification information corresponding to the particular roll-out recyclable cart 10. For example, the non-optical identifier 30 includes an alphanumeric identification code (ID) associated with the roll-out recyclable cart 10. In this example, the information on the non-optical identifier 30 is set or established during assembly of the roll-out recyclable cart 10. The recyclable truck 50 collects information about the tipped roll-out recyclable cart 10 through the non-optical identifier 30. Although described in this example as an RFID tag, those skilled in the art and having the benefit of this disclosure may understand other types of non-optical identifiers for storing such information. In one example, the non-optical identifier 30 is written with information about the optical identifier 32.

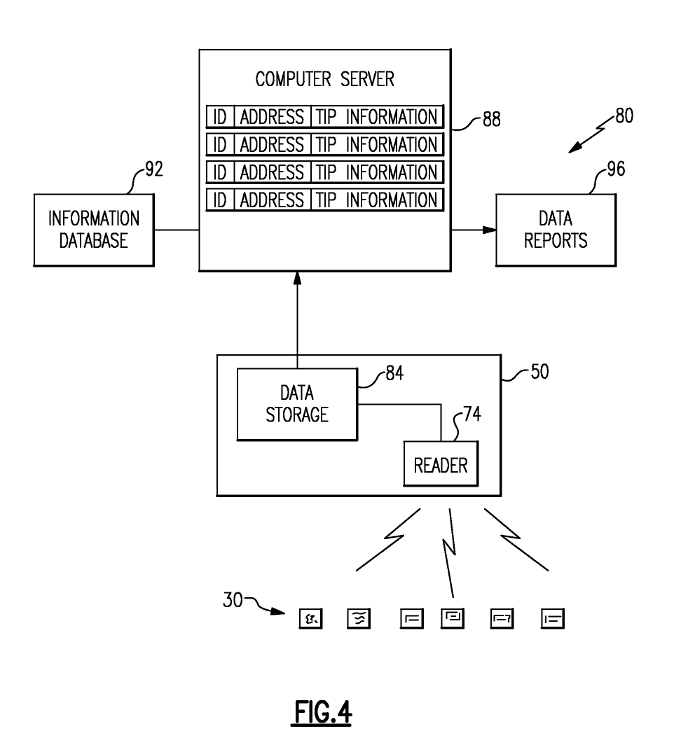

FIG. 4 schematically illustrates of an example system 80 utilizing the roll-out recyclable cart 10 of FIG. 1 with the non-optical identifier 30. The system 80 collects and stores data within data storage 84 from at least one non-optical identifier 30 using the reader 74. This data collection occurs within the recyclable truck 50 and includes saving identification from more than one non-optical identifier 30. Example information may include recording the data and time of the tip, GPS data, and recording the ID of the tipped roll-out recyclable cart 10 obtained from the non-optical identifier 30.

The data within the data storage 84 communicates to a computer server 88. Communicating the data to the computer server 88 may take place after the recyclable truck 50 returns from collecting recyclables on a particular route or after filling the recyclable bin 54 with recyclables. In another example, the recyclable truck 50 communicates collected data wirelessly after each tip, or periodically.

The computer server 88 associates the ID, date, and time information with further information by communicating with an information database 92. The ID from the non-optical identifier 30 associates the roll-out recyclable cart 10 with other information in the database 92, such as an address corresponding to a resident utilizing the roll-out recyclable cart 10. Thus, the non-optical identifier 30 provides the computer server 88 with the information needed to associate an address for the roll-out recyclable cart 10 with date and time information about the tip.

In another example, the identification information provided to the reader 74 from the non-optical identifier 30 already contains the address information about the roll-out recyclable cart 10, and perhaps other information such as mold date, distribution date, or both. In such an example, the computer server 88 obtains necessary information directly from the non-optical identifier 30 rather than associating the ID with data in the information database 92

The computer server 88 generates data reports 96 using the associations from the computer server 88. Example data reports 96 generate recyclable collection bills for customers based on the number of tips associated with their roll-out recyclable cart 10. Other examples, such as when using another type of cart, also generate collection bills based on the number of tips. Other example data reports 96 plan routes for the recyclable truck 50, which are optimized or otherwise modified based on the number of tips associated with a particular area. That is, the recyclable truck 50 would plan a shorter route if, over time, the smaller route resulted in as many tips, and therefore as much recyclables, as another larger route. Thus, the system 80 estimates future volumes of recyclables based on the past number of tips of the roll-out recyclable cart 10 at particular locations.

Other examples may include providing a website for customers to track their roll-out recyclable cart 10 using ID from the non-optical identifier 30. In such an example, a resident logs on to an internet website, provides their ID, and tracks progress of repairs to their roll-out recyclable cart 10, for example. Recyclable truck weight 50 and average weight per stop are also reported on the internet website or elsewhere in some examples.

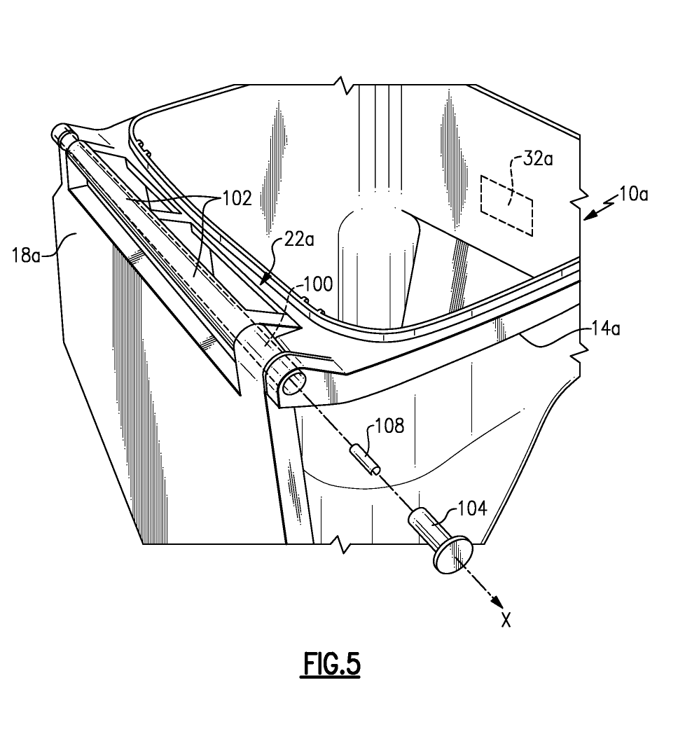

The non-optical identifier 30 is sometimes added to the roll-out recyclable cart 10 after manufacturing, rather than as a controlled manufacturing step. For example, referring to FIG. 5, another example roll-out recyclable cart 10a includes a hinge member 22a that defines a chamber 100, here a cylindrical chamber. In this example, the hinge member 22a connects to a handle section 102 used to manipulate the position of the roll-out recyclable cart 10a. An optical identifier 32a is secured to a outer surface of the roll-out recyclable cart 10a during manufacturing.

In this example, the hinge member 22a includes portions molded with both the hollow body portion 14a and the lid member 18a, while the handle section 102 is molded jtogether with the hollow body portion 14a. Removing a pin 104 from the hinge member 22a along a hinge axis X permits separating the lid member 18a from the hollow body portion 14a, and exposes the chamber 100, which extends along the hinge axis 104 through the hinge member 22a and the handle section 102. In this example, the chamber 100 stores a non-optical identifier 108, here a flexible RFID tag. The pin 104 stores the non-optical identifier 108 in another examples.

The walls of the chamber 100 protect the non-optical identifier 108 during use of the roll-out recyclable cart 10a. Further, utilizing the chamber 100 to hold the non-optical identifier 108 facilitates adding the non-optical identifier 108 to the roll-out recyclable cart 10a, even after manufacturing the roll-out recyclable cart 10a. In such examples, the optical identifier 32a, rather than both the optical identifier 32a and the non-optical identifier 108, includes specific information about the roll-out recyclable cart 10 because only the optical identifier 32a was secured or associated with the roll-out recyclable cart 10 as part of a controlled manufacturing step, for example. If the non-optical identifier 108 is added later, or otherwise lacks an association with the roll-out recyclable cart 10, the non-optical identifier 108 may need to be associated with the optical identifier 32, the roll-out recyclable cart 10, or both.

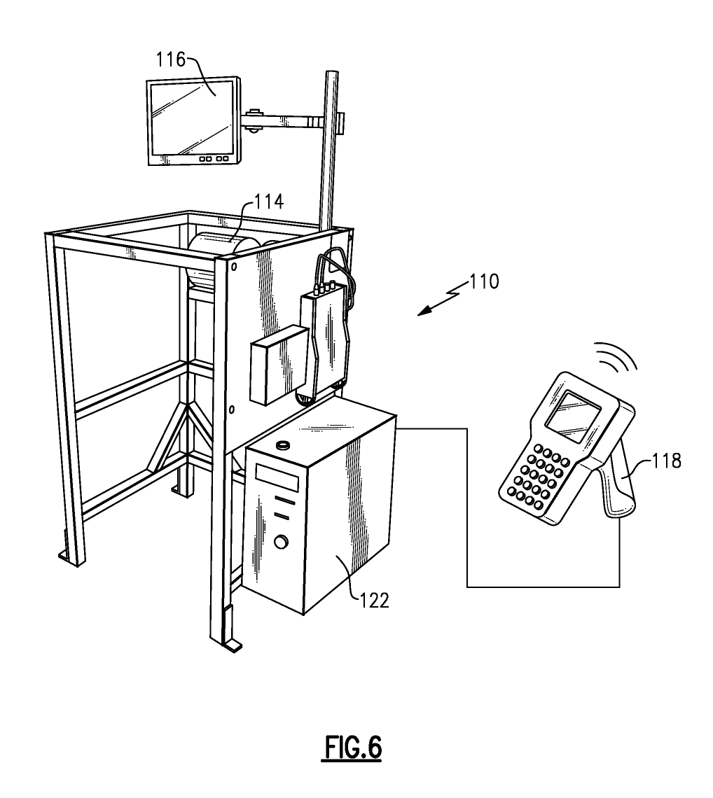

Referring to FIG. 6 with continuing reference to FIG. 5, a fixture 110 includes a non-optical scanner 114 for reading the non-optical identifier 108 and a handheld optical scanner 118 for reading the optical identifier 32. Other examples include read the non-optical identifier 108 and the optical identifier 32 with a single handheld scanner. A display 116 displays scanning results for example.

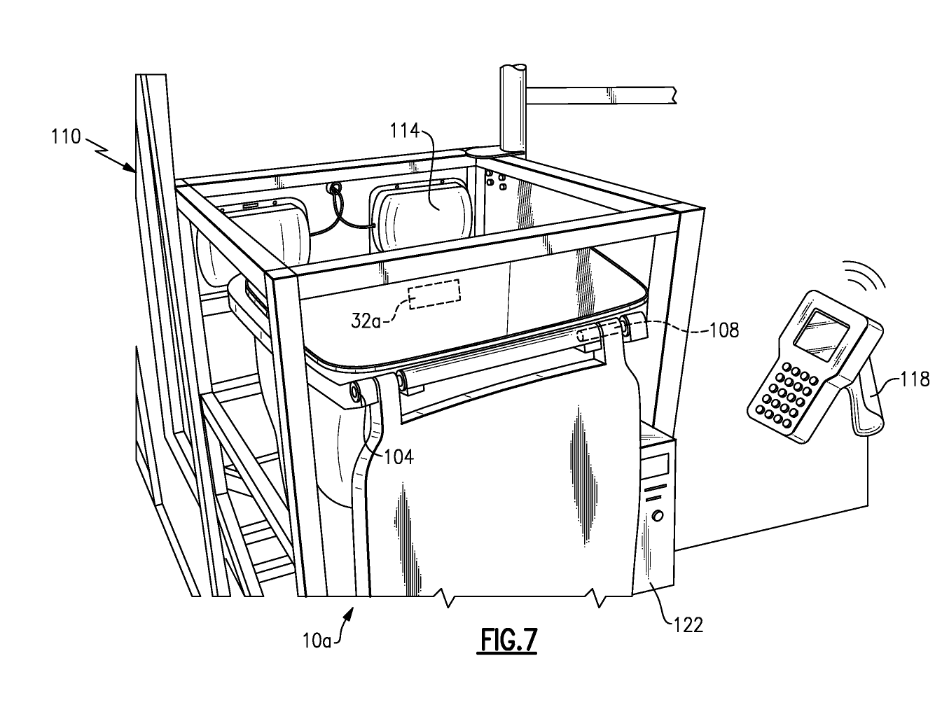

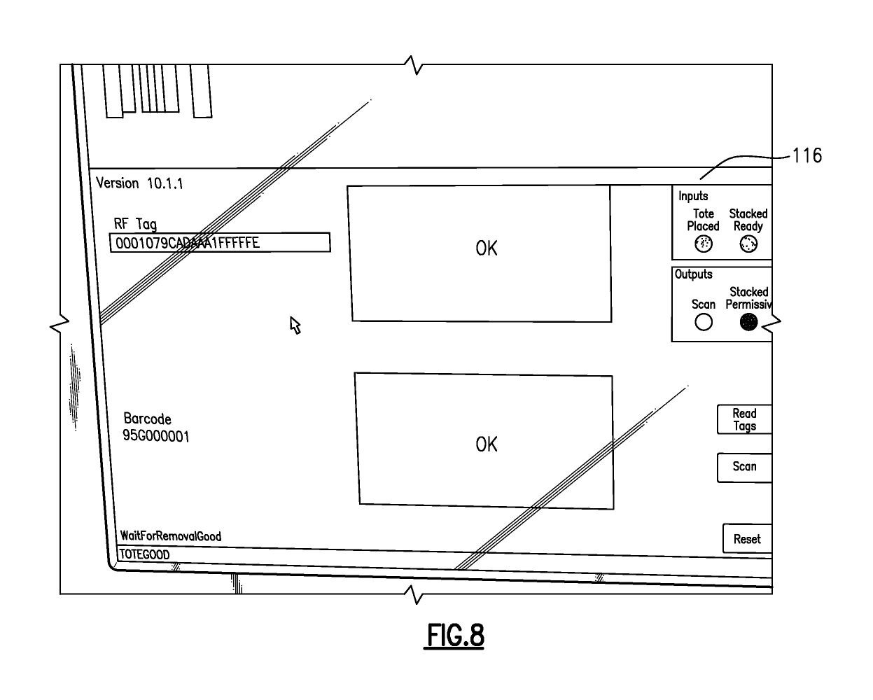

Referring to FIG. 7, the roll-out recyclable is moved within the fixture 110 to properly position the non-optical identifier 108 and the optical identifier 32 for scanning. A general purpose computer 122 is used for associating the optical identifier 32 with the non-optical identifier 114. The fixture 110 also verifies presence of the optical identifier 32 and the non-optical identifier 114. FIG. 8 illustrates a screen shot from the display 116 showing an example reading from the non-optical scanner 114 and the optical scanner 118.

Although a preferred embodiment has been disclosed, a worker of ordinary skill in this art would recognize that certain modifications would come within the scope of this invention. For that reason, the following claims should be studied to determine the true scope and content of this invention.

We claim:

1. A trackable cart comprising:
a body having an upper body portion defining an opening for loading and unloading items from the body;
a lid for closing the opening of the body, the lid pivotably attached to the body along a hinge axis; and
a identifier contained adjacent the hinge axis.

2. The trackable cart of claim 1 including a hinge member pivotably attaching the lid to body, the hinge member containing the identifier.

3. The trackable cart of claim 1 including a hinge member having portions defining a cylindrical chamber that receives at least one pin, the pin pivotably attaching the lid to the body.

4. The trackable cart of claim 3 wherein the cylindrical chamber contains the identifier.

5. The trackable cart of claim 3 wherein the cylindrical chamber has an elliptical cross-section.

6. The trackable cart of claim 3 wherein at least one of the body and the lid defines the cylindrical chamber.

7. The trackable cart of claim 4 wherein the pin limits movement of the identifier.

8. The trackable cart of claim 1 including at least one wheel on a lower rear portion of the body.

9. The trackable cart of claim 1 wherein the identifier is a radio frequency identification tag.

10. A trackable cart comprising:
a body having an upper body portion defining an opening for loading and unloading items from the body;
a lid for closing the opening of the body;
a hinge member pivotally connecting the body to the lid;
a handle; and
a identifier, wherein at least one of the hinge member and the handle contains the identifier.

11. The trackable cart of claim 10 wherein at least a portion of the hinge member or the handle is molded with the body or the lid.

12. The trackable cart of claim 10 wherein the items include recyclables, trash, or both.

13. A method of assembling a trackable cart comprising:
(a) securing a non-optical identifier relative a cart, the cart having an associated optical identifier;
(b) reading the non-optical identifier; and
(c) associating the non-optical identifier with the optical identifier.

14. The method of claim 13 including scanning the optical identifier.

15. The method of claim 14 including scanning using a handheld scanner.

16. The method of claim 13 wherein the non-optical identifier includes a serial number or a bar code.

17. The method of claim 13 wherein the non-optical identifier includes a radio frequency identification tag.

18. The method of claim 13 wherein the securing step includes positioning the non-optical identifier within a hinge of the cart.

19. The method of claim 13 including associating an location with the non-optical identifier.

20. The method of claim 13 wherein the address includes a mailing address or a street address.
